(19) United States
(12) Patent Application Publication
(10) Pub. No.: US 2017/0041711 A1
(43) Pub. Date: Feb. 9, 2017

(54) REPRODUCTION APPARATUS AND REPRODUCTION METHOD

(71) Applicant: KYOCERA Corporation, Kyoto (JP)

(72) Inventor: Atsuhisa Inakoshi, Yokohama-shi, Kanagawa (JP)

(73) Assignee: KYOCERA Corporation, Kyoto (JP)

(21) Appl. No.: 15/303,791

(22) PCT Filed: Apr. 22, 2015
(86) PCT No.: PCT/JP2015/002195

§ 371 Date: Oct. 13, 2016

(30) Foreign Application Priority Data
Apr. 23, 2014 (JP) 2014-089410

(51) Int. Cl. H04R 5/04; H04R 1/10; H04R 5/033; H04R 29/00

(52) U.S. Cl. CPC H04R 5/04; H04R 29/001; H04R 1/1091; H04R 5/033; H04R 1/1016

(57) ABSTRACT

A reproduction apparatus includes a biological sensor located at an earphone to acquire biological information and a controller for controlling an output operation of a content based on an acquisition state of the biological information.

### CROSS REFERENCE TO RELATED APPLICATION

This application claims priority to and the benefit of Japanese Patent Application No. 2014-089410 (filed on Apr. 23, 2014), the entire contents of which are incorporated herein by reference.

### TECHNICAL FIELD

This disclosure relates to a reproduction apparatus and a reproduction method.

### BACKGROUND

Conventionally, there is known an apparatus for realizing several functions by using biological information.

### SUMMARY

A reproduction apparatus of the disclosure herein includes:

a biological sensor located at an earphone to acquire biological information; and

a controller for controlling an output operation of a content based on an acquisition state of the biological information.

A reproduction method of the disclosure herein is a reproduction method of a reproduction apparatus, the reproduction method including:

a step of acquiring biological information from a biological sensor located at an earphone; and

a step of controlling an output operation of a content to the earphone based on an acquisition state of the biological information.

### BRIEF DESCRIPTION OF THE DRAWINGS

In the accompanying drawings:

FIG. 1 is a functional block diagram of a main section of a reproduction apparatus according to one embodiment of the disclosure herein;

FIGS. 2A and 2B are diagrams illustrating an example of arrangement of a right ear biological sensor on a right ear insertion unit of an earphone;

FIG. 3 is a diagram illustrating a state in which the right ear insertion unit of FIGS. 2A and 2B is inserted into the ear; and

FIG. 4 is a flowchart illustrating an example of an operation performed by a mobile phone controller.

### DETAILED DESCRIPTION

Conventionally known apparatuses switch the functions based on the biological information acquired, assuming that the biological information may be acquired. Therefore, when, for example, a user stops using the above apparatuses and a detection means of the biological information does not detect the biological information, the above apparatuses cannot switch the functions. Generally, when the user stops using the apparatus, the user is assumed to turn off the power of the apparatus. However, when the user forgets to turn the power off, or when the power is ON due to some erroneous operations, the power of the apparatus is ON against a user's intention. In this case, when the apparatus is capable of detecting a user's using state thereof and controlling an operation on its own, it is highly convenient to the user.

Therefore, it could be helpful to provide a reproduction apparatus and a reproduction method which enhance convenience.

Hereinafter, an embodiment of the disclosure herein will be described with reference to the drawings.

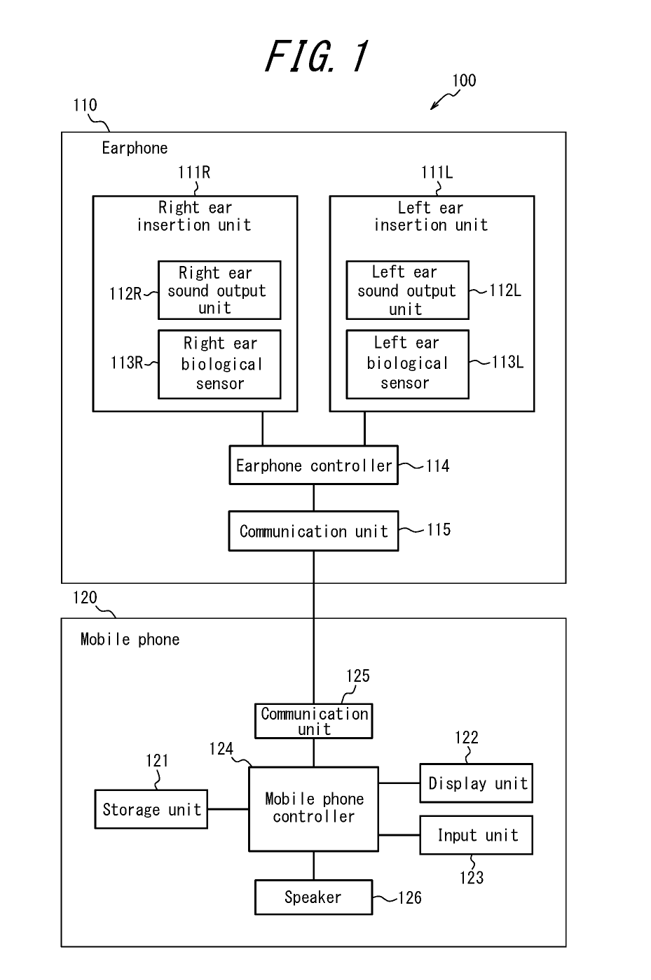

FIG. 1 is a functional block diagram of a main section of a reproduction apparatus according to one embodiment of the disclosure herein. A reproduction apparatus 100 includes, as illustrated in FIG. 1, for example, an earphone 110 and a mobile phone 120.

A user listens to a content by using the reproduction apparatus 100. In particular, the user operates the mobile phone 120 to reproduce the content. The earphone 110 includes biological sensors 113R and 113L located thereat, each of which may acquire biological information when the user is wearing the earphone 110. The reproduction apparatus 100, based on whether the biological sensors 113R and the 113L are acquiring the biological information, determines whether the user is using the reproduction apparatus 100 and outputs the content accordingly. Here, the content includes a sound content such as music information, voice information, and the like and a video content including video information such as TV information, movies, and the like.

The earphone 110 includes a right ear insertion unit 111R, a left ear insertion unit 111L, an earphone controller 114, and a communication unit 115. The user, to listen to the content, inserts the right ear insertion unit 111R and the left ear insertion unit 111L into the right ear and the left ear, respectively. The right ear insertion unit 111R and the left ear insertion unit 111L are preferably in a shape which may be stably sit in the user's ears.

The right ear insertion unit 111R includes a right ear sound output unit 112R and a right ear biological sensor 113R. The right ear sound output unit 112R is constituted by using, for example, a speaker unit and outputs sound of the content reproduced by the reproduction apparatus 100. Also, the right ear biological sensor 113R is constituted by using, for example, a blood flow sensor for measuring blood flow or a pulse wave sensor for measuring a pulse wave, which serve as the biological information, and acquires the biological information of the user wearing the earphone 110.

The left ear insertion unit 111L is, for example, bilaterally symmetric to the right ear insertion unit 111R and includes a left ear sound output unit 112L and a left ear biological sensor 113L. The left ear sound output unit 112L outputs the sound of the content reproduced. The left ear biological sensor 113L acquires the biological information of the user wearing the earphone 110. The left ear sound output unit 112L and the left ear biological sensor 113L may have the same configurations as the right ear sound output unit 112R and the right ear biological sensor 113R, respectively. Also, the reproduction apparatus 100, for a stereophonic content, may perform a stereophonic output by using the right sound output unit 112R and the left sound output unit 112L.

Note that, hereinafter, when there is no need to distinguish between the right ear insertion unit and the left ear insertion unit, between the right ear sound output unit and the left ear sound output unit, and between the right ear biological sensor and the left ear biological sensor, the insertion unit, the sound output unit, and the biological sensor are referred to as an insertion unit 111, a sound output unit 112, and a biological sensor 113, respectively.

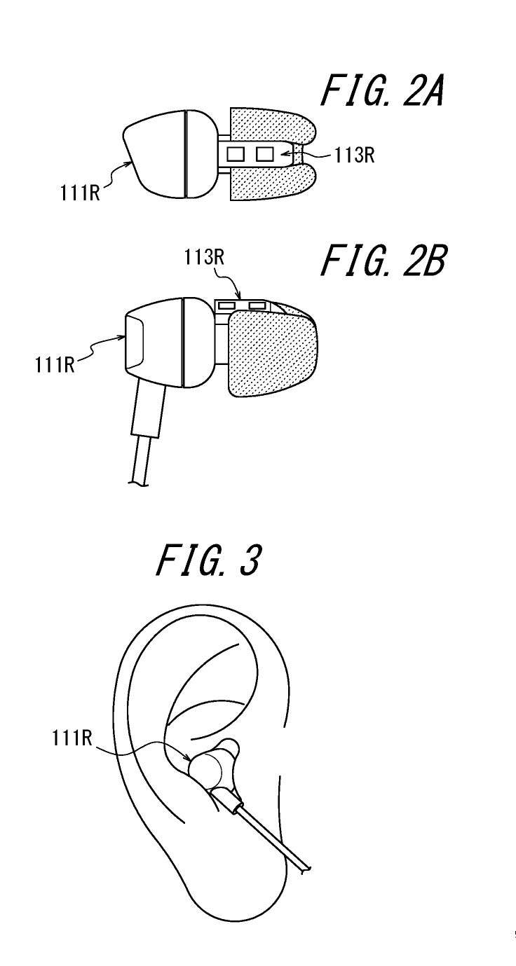

FIGS. 2A and 2B are diagrams illustrating an example of arrangement of the right ear biological sensor 113R of the right ear insertion unit 111R of the earphone 110. FIG. 2A illustrates a top view, and FIG. 2B illustrates an elevation view. The right ear biological sensor 113R, as illustrated in FIGS. 2A and 2B, for example, includes the right ear biological sensor 113R on an upper surface of the right ear insertion unit 111R. Thereby, when the user inserts the right ear insertion unit 111R into the right ear as illustrated in FIG. 3, the right ear biological sensor 113R comes into contact with an upper portion of the ear canal of the right ear and thus may acquire the biological information at a contact site.

The left ear biological sensor 113L is arranged, for example, at a position of the left ear insertion unit 111L corresponding to the right ear biological sensor 113R described above, and may acquire the biological information of the user at an upper portion of the ear canal of the left ear. In this manner, the right ear biological sensor 113R and the left ear biological sensor 113L acquire the biological information at different sites: the right ear canal and the left ear canal. Note that the biological sensor 113 is arranged in a manner described above by way of example only and may be arranged on the insertion unit 111 in such a manner as to come into contact with, for example, a lower portion or a side portion of the ear canal.

When the biological sensor 113 is, for example, the blood flow sensor, the blood flow sensor includes a light emitter for emitting a laser beam or an LED (Light Emitting Diode) and a photodetector such as PT (Phototransistor), PD (Photodiode), or the like. The blood flow sensor emits the light from the light emitter to a measuring site of blood flow data serving as the biological information of the user and measures a Doppler shift frequency of scattered light by means of the photodetector, thereby measures the blood flow data. In measurement using the light as described above, the blood flow sensor does not necessarily need to contact with the ear canal.

Here, a blood flow measurement technique using the Doppler shift will be described. A device for measuring the blood flow using the Doppler shift includes a light emitting unit for emitting the laser beam into a tissue of a living body, a photodetector unit for receiving the scattered light from inside the tissue of the living body, and a measurement unit for calculating the blood flow based on a result of the measurement of the laser beam received. The emission unit is constituted by using, for example, a laser diode, and the photodetector unit is constituted by using the photodiode.

When the light emitting unit emits the laser beam into the tissue of the living body, the scattered light scattered from blood cells which are moving is subjected to a frequency shift (the Doppler shift) due to Doppler effect in proportion to a moving speed of the blood cells in the blood. The measurement unit detects a beat signal generated by optical interference between the scattered light from a static tissue and the scattered light from the blood cells which are moving. The beat signal is represented by a function of time indicative of intensity. Then, the measurement unit generates, from the beat signal, a power spectrum represented by a function of the frequency indicative of power. In the power spectrum of the beat signal, the Doppler shift frequency increases in proportion to the speed of the blood cells, and the power corresponds to an amount of the blood cells. Then, the measurement unit acquires the blood flow by multiplying the power spectrum of the beat signal by the frequency and integrating.

When the biological sensor 113 is, for example, the pulse wave sensor, the pulse wave sensor includes, for example, the light emitter such as the LED or the like and the photodetector such as the PT, the PD, or the like. In the pulse wave sensor, the light emitter emits the light to a measurement site of pulse wave data serving as the biological information of the user and the photodetector receives the reflected light. Thereby, the pulse wave data is measured. In measurement using the light as described above, the pulse wave sensor does not necessarily need to contact with the ear canal.

The earphone controller 114 is a processor for controlling overall operations of the earphone 110. The earphone controller 114, for example, based on information received by the communication unit 115, controls operations of the sound output unit 112 and the biological sensor 113. Also, the earphone controller 114 controls, for example, the communication unit 115 to transmit the biological information acquired by the biological sensor 113 to the mobile phone 120.

The communication unit 115 connects to and communicates with the mobile phone 120 in a wired manner or a wireless manner using Bluetooth® (Bluetooth is a registered trademark in Japan, other countries, or both) or the like. For example, the earphone 110 receives, via the communication unit 115, a sound signal transmitted from the mobile phone 120. Also, the earphone 110 transmits the biological information acquired by the biological sensor 113 to the mobile phone 120 via the communication unit 115.

The mobile phone 120 is, for example, a smartphone and connected to the earphone 110 in the wired or wireless manner. The mobile phone 120 includes a storage unit 121, a display unit 122, an input unit 123, a mobile phone controller 124, a communication unit 125, and a speaker 126. The mobile phone 120, depending on the content, reproduces the content by using the earphone 110 or the display unit 122, or both.

The storage unit 121 may be constituted by using, for example, a semiconductor memory and stores various information and a program for operating the mobile phone 120. The storage unit 121 stores, for example, the content to be reproduced by the reproduction apparatus 100. Also, the storage unit 121 may store the biological information acquired by the biological sensor 113 of the earphone 110.

The display unit 122 is a display device such as a liquid crystal display, an organic EL display, or an inorganic EL display. The display unit 122 outputs the video of the content reproduced by the reproduction apparatus 100. The video output by the display unit 122 may be a video of the content stored in the storage unit 121 or, for example, a video of a video content containing sound received by the communication unit 125 from a content provider.

The input unit 123 receives an input operation from the user and is constituted by using, for example, an operation button (an operation key). Note that the input unit 123 may be constituted by using a touch panel and, by displaying the input unit 123 for receiving the input operation from the user in a portion of the display unit 122, may receive a touch input operation from the user. The user, for example, by operating the input unit 123, may select the content reproduced by the reproduction apparatus 100.

The mobile phone controller 124 is a processor for controlling overall operations of the mobile phone 120. The mobile phone controller 124 controls, for example, an output operation of the content by the sound output unit 112 and the display unit 122. In particular, when, for example, the reproduction apparatus 100 reproduces a sound content such as music, the mobile phone controller 124 generates the sound signal to be supplied to the sound output unit 112 and transmits the sound signal thus generated to the earphone 110 via the communication unit 125. The sound signal is input to both of the sound output units 112 by the earphone controller 114. Thereby, the sound content is reproduced. Also, in order to end the output of the sound content being reproduced, the mobile phone controller 124 ends generating the sound signal. In order to end the output of the sound content, the mobile phone controller 124 ends, for example, an application associated with the sound content.

Also, for example, when the reproduction apparatus 100 reproduces the video content containing the sound, the mobile phone controller 124, based on reception thereof from the content provider, generates the sound signal and the video signal to be provided to the sound output unit 112 and the display unit 122, respectively. Then, by transmitting the sound signal thus generated to the earphone 110 via the communication unit 125, the mobile phone controller 124 supplies the sound signal to the sound output unit 112 from the earphone controller 114 and also supplies the video signal to the display unit 122. Thereby, the video content is reproduced. In order to end the output of the video content being reproduced, the mobile phone controller 124 ends generating the sound signal and the video signal. In order to resume the reproduction of the video content, the video content is reproduced based on the reception thereof from the content provider by the communication unit 125.

The mobile phone controller 124, based on an acquisition state of the biological information by the biological sensor 113, may control a content output operation. For example, the mobile phone controller 124 ends the content output operation when the biological sensor 113 is not acquiring the biological information, and executes the content output operation when the biological sensor 113 is acquiring the biological information.

For example, when the biological sensor 113 is arranged on the upper surface of the insertion unit 111 as described above, the biological sensor 113 acquires the biological information while sitting in the user's ear and in contact with the upper portion of the ear canal. Therefore, since the mobile phone controller 124 executes the content output operation while the biological sensor 113 is acquiring the biological information, the reproduction apparatus 100 may reproduce the content when the user is wearing the insertion unit 111 inserted in the user's ear.

Also, the biological sensor 113 does not acquire the biological information when not sitting in the user's ear. Therefore, since the mobile phone controller 124 ends the content output operation while the biological sensor 113 is not acquiring the biological information, the reproduction apparatus 100 may end the content when the user is not wearing the insertion unit 111 in the user's ear.

Also, for the sound content, when the biological sensor 113 is not acquiring the biological information, the mobile phone controller 124 may stop a sound content output operation. When the sound content stops being output and then reproduction of the same sound content is resumed, the sound content is reproduced from a portion where the output thereof is stopped. Therefore, in a case in which, for example, the user removes the earphone 110 from the ear leaving the sound content being reproduced and then wears the earphone 110 again, the reproduction apparatus 100 stops the reproduction of the sound content when the earphone 110 is removed from the ear and reproduces the sound content from the portion where the reproduction thereof is stopped when the user wears the earphone 110. Therefore, when the user wears the earphone 110, the user may listen to the sound content from a portion thereof being reproduced when the earphone 110 is removed, without performing a stopping operation, a rewinding operation, or the like.

Also, as illustrated in FIG. 1, when the earphone 110 includes the right ear insertion unit 111R having the right ear sound output unit 112R and the right ear biological sensor 113R located thereat and the left ear insertion unit 111L having the left ear sound output unit 112L and the left ear biological sensor 113L located thereat, the mobile phone controller 124 may control the content output operation based on the acquisition state of the biological information by the right ear biological sensor 113R and the left ear biological sensor 113L. For example, the mobile phone controller 124 may control such that the content is output from the sound output unit 112 of the insertion unit 111 having the biological sensor 113 which is acquiring the biological information.

For example, the output of the sound content will be described. The mobile phone controller 124, when both the right ear biological sensor 113R and the left ear biological sensor 113L are acquiring the biological information, generates the sound signal such that the sound is output from both the right ear sound output unit 112R and the left ear sound output unit 112L and supplies the sound signal thus generated from the earphone controller 114 to the right ear sound output unit 112R and the left ear sound output unit 112L. As described above, when both the right ear biological sensor 113R and the left ear biological sensor 113L are acquiring the biological information, both the right ear insertion unit 111R and the left ear insertion unit 111L are assumed to be sitting in the user's ear. Therefore, it is preferable that the sound is output from both the right ear sound output unit 112R and the left ear sound output unit 112L. Note that, when the sound is output from both the right ear sound output unit 112R and the left ear sound output unit 112L as described above and the sound content is the stereophonic content, the mobile phone controller 124 may generate the sound signal such that both the right ear sound output unit 112R and the left ear sound output unit 112L perform the stereophonic output.

Also, when the right ear biological sensor 113R is acquiring the biological information and the left ear biological sensor 113L is not acquiring the biological information, the mobile phone controller 124 generates the sound signal such that the sound is output from the right ear sound output unit 112R alone, and supplies the sound signal thus generated from the earphone controller 114 to the right ear sound output unit 112R. In this case, the sound is output from the right ear sound output unit 112R alone, without being output from the left ear sound output unit 112L. That is, when the right ear biological sensor 113R is acquiring the biological information and the left ear biological sensor 113L is not acquiring the biological information, it is assumed that the right ear insertion unit 111R alone is sitting in the user's ear. Therefore, the reproduction apparatus 100 needs to output the sound from the right ear sound output unit 112R alone. Note that, when the left ear biological sensor 113L is acquiring the biological information and the right ear biological sensor 113R is not acquiring the biological information, the mobile phone controller 124 generates the sound signal such that, by contrast, the sound is output from the left ear sound output unit 112L alone, and supplies the sound signal thus generated from the earphone controller 114 to the left ear sound output unit 112L.

Note that, when the mobile phone controller 124 controls such that the sound is output from only one of the right ear sound output unit 112R and the left ear sound output unit 112L, the mobile phone controller 124 may generate the sound signal such that the right ear sound output unit 112R or the left ear sound output unit 112L performs a monophonic output. The user may feel strange with the sound when listening to the stereo output from only one of the right ear sound output unit 112R and the left ear sound output unit 112L. However, the monophonic output may suppress such a feeling.

Also, when the mobile phone controller 124 controls such that the sound is output only one of the right ear sound output unit 112R and the left ear sound output unit 112L, the mobile phone controller 124 may control to turn the volume up as compared to the volume of the sound output from both the right ear sound output unit 112R and the left ear sound output unit 112L. In this case, when the sound is output from only one of the right ear sound output unit 112R and the left ear sound output unit 112L, the user may easily listen to the sound content.

When neither the right ear biological sensor 113R nor the left ear biological sensor 113L is acquiring the biological information, it is assumed that neither the right ear insertion unit 111R nor the left ear insertion unit 111L is sitting in the user's ear. Therefore, the mobile phone controller 124 does not supply the sound signal to the right ear sound output unit 112R and the left ear sound output unit 112L. Thereby, the reproduction apparatus 100 may suppress power consumption when it is assumed that the user is not listening to the content.

The communication unit 125 connects to and communicates with the earphone 110 in the wired or wireless manner. For example, the sound signal generated by the mobile phone controller 124 is transmitted to the earphone 110 via the communication unit 125. Also, for example, the acquisition state of the biological information by the biological sensor 113 is acquired from the earphone 110 via the communication unit 125. Further, the communication unit 125 receives the video content by performing, for example, a radio communication with a server of the content provider. Although in FIG. 1 the mobile phone 120 includes one communication unit 125, the mobile phone 120 may include two or more communication units including one communication unit to connect to the earphone 110 and another communication unit to connect to the server of the content provider.

The speaker 126 outputs the sound. The speaker 126 outputs the sound based on, for example, the sound signal supplied from the mobile phone controller 124. The mobile phone controller 124, for example, when the mobile phone 120 and the earphone 110 are not connected to each other, supplies the sound signal to the speaker 126 such that the sound content is output from the speaker 126.

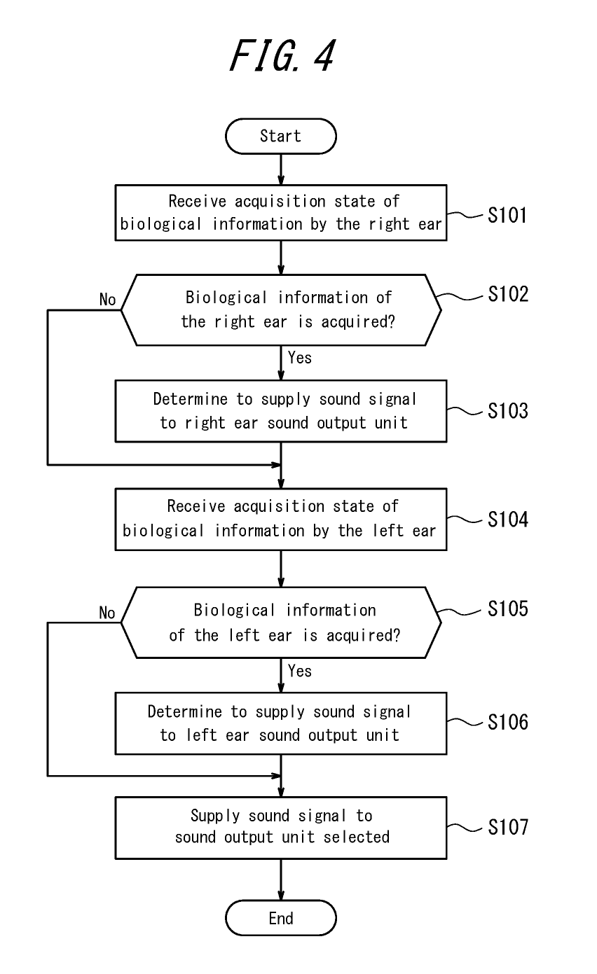

Referring to FIG. 4, next, an example of the operation performed by the reproduction apparatus 100 will be described. FIG. 4 is a flowchart illustrating the operation performed by the mobile phone controller 124. Here, a case in which the reproduction apparatus 100 outputs the sound content based on the acquisition state of the biological information by the right ear biological sensor 113R and the left ear biological sensor 113L will be described.

First, the mobile phone controller 124 receives, via the communication unit 125, the acquisition state of the biological information by the right ear biological sensor 113R (step S101). Then, the mobile phone controller 124, based on the acquisition state thus received, determines whether the biological information of the right ear is acquired (step S102). For example, the mobile phone controller 124, when the data acquired by the biological sensor 113 corresponds to data of a value of predetermined blood flow or predetermined pulse wave preliminarily stored, determines that the biological information is acquired.

The mobile phone controller 124, when determining that the biological information of the right ear is acquired (Yes at step S102), determines that the user is wearing the right ear insertion unit 111R in the right ear and determines to supply the sound signal to the right ear sound output unit 112R (step S103). On the other hand, the mobile phone controller 124, when determining that the biological information of the right ear is not acquired (No at step S102), determines that the user is not wearing the right ear insertion unit 111R in the right ear and proceeds to step S104.

Next, the mobile phone controller 124, for the left ear, performs steps similar to steps S101 to S103. That is, the mobile phone controller 124 receives, via the communication unit 125, the acquisition state of the biological information by the left ear biological sensor 113L (step S104). Then, the mobile phone controller 124, based on the acquisition state thus received, determines whether the biological information of the left ear is acquired (step S105).

The mobile phone controller 124, when determining that the biological information of the left ear is acquired (Yes at step S105), determines that the user is wearing the left ear insertion unit 111R in the left ear and determines to supply the sound signal to the left ear sound output unit 112L (step S106). On the other hand, the mobile phone controller 124, when determining that the biological information of the left ear is not acquired (No at step S105), determines that the user is not wearing the left ear insertion unit 111L in the left ear and proceeds to step S107.

Then, the mobile phone controller 124 generates the sound signal to be supplied to the sound output unit 112 selected and supplies the sound signal to the sound output unit 112 via the communication unit 125 (step S107). The mobile phone controller 124, for example, when determining to supply the sound signal to both the right ear sound output unit 112R and the left ear sound output unit 112L, supplies the sound signal to both the right ear sound output unit 112R and the left ear sound output unit 112L at step S107, such that the sound content is subjected to the stereophonic output according to the sound content. Also, for example, when the mobile phone controller 124 determines to supply the sound signal to one of the right ear sound output unit 112R and the left ear sound output unit 112L, supplies the sound signal to one of the right ear sound output unit 112R or the left ear sound output unit 112L which has been selected, such that the sound content is subjected to the monophonic output from one of the right ear sound output unit 112R and the left ear sound output unit 112L. Further, when the mobile phone controller 124 determines that the biological information is not acquired both at steps S102 and S105 (No at steps S102 and S105), the mobile phone controller 124 does not supply the sound signal to the sound output unit 112. In this case, the mobile phone controller 124 ends or suspends the sound content.

The mobile phone controller 124, in a state in which a communication between the earphone 110 and the mobile phone 120 is established, repetitively performs the flow in FIG. 4 periodically, non-periodically, or continuously, thereby determining whether the insertion unit 111 is sitting in the ear based on the acquisition state of the biological information by the biological sensor 113 and changing an output state of the sound content.

As described above, the reproduction apparatus 100 controls the output of the content based on the acquisition state of the biological information by the biological sensor 113. Since the acquisition state of the biological information corresponds to whether the user is wearing the earphone 110 in the ear(s), the reproduction apparatus 100 may reproduce the content based on whether the user is wearing the earphone 110. Therefore, the user may reproduce or end the content by wearing or taking off the earphone 110, instead of operating the input unit 123.

Also, since the reproduction and end of the reproduction of the content are associated with whether the user is wearing the earphone 110, when the user takes off the earphone 110 forgetting to end the content, the reproduction apparatus 100 may end or suspend the content on its own. Therefore, power consumption of the reproduction apparatus 100 due to the reproduction operation unintended by the user may be prevented.

Also, since the reproduction apparatus 100 determines whether the user is wearing the earphone 110 in association with the acquisition state of the biological information by the biological sensor 113, whether the user is actually wearing the earphone 110 may be detected highly accurately. Therefore, the reproduction apparatus 100 is highly convenient to the user.

Note that the disclosure herein is not limited to the above embodiment but may be modified or changed in a variety of manners. For example, a function and the like included in each constituent, step and the like may be rearranged without logical inconsistency, so as to combine a plurality of constituents or steps together or to separate them.

For example, although in the above embodiment the reproduction apparatus 100 includes the earphone 110 and the mobile phone 120, the reproduction apparatus 100 may include, instead of the mobile phone 120, any electronic apparatus for outputting the content. The reproduction apparatus 100 may control the output of the content by using a variety of electronic apparatuses including, for example, a portable music player, a laptop computer, a tablet computer, a gaming device, and the like.

Also, although in the above embodiment the reproduction apparatus 100 ends or suspends the output of the content when the biological sensor 113 is not acquiring the biological information, the control performed by the reproduction apparatus 100 is not limited thereto. For example, when the biological sensor 113 is not acquiring the biological information, the reproduction apparatus 100 may control to mute the sound of the content output from the sound output unit 112. In this way, the sound is prevented from leaking from the earphone 110 when the user is not wearing the earphone 110, thereby enhancing convenience.

When the biological sensor 113 is not acquiring the biological information, the reproduction apparatus 100 may, for example, switch an output destination of the sound of the content. For example, the reproduction apparatus 100 switches a destination of the sound signal associated with the content from the sound output unit 112 to the speaker 126 of the mobile phone 120. In this way, the reproduction apparatus 100, when determining that the user is not wearing the earphone 110, may output the sound in such a manner that the user may listen to the sound, thereby enhancing the convenience. Note that the output destination of the sound may be, for example, a speaker unit and the like separately connected to the reproduction apparatus 100.

1. A reproduction apparatus comprising:
a biological sensor located at an earphone to acquire biological information; and
a controller for controlling an output operation of a content based on an acquisition state of the biological information.

2. The reproduction apparatus according to claim 1, wherein the controller ends or suspends the output operation of the content when the biological sensor is not acquiring the biological information, or executes the output operation of the content when the biological sensor is acquiring the biological information.

3. The reproduction apparatus according to claim 2, wherein the content is a video content including sound, and the controller ends the output operation of the video content when the biological sensor is not acquiring the biological information.

4. The reproduction apparatus according to claim 2, wherein the content is a sound content, and the controller ends the output operation of the sound content when the biological sensor is not acquiring the biological information.

5. The reproduction apparatus according to claim 1, wherein the controller mutes sound of the content being output when the biological sensor is not acquiring the biological information.

6. The reproduction apparatus according to claim 1, wherein
the earphone is provided with a sound output unit for outputting the content and the biological sensor, both of which are located at insertion units to be inserted into the left ear and the right ear, respectively, and
the controller, based on the acquisition state of the biological information by a right ear biological sensor and a left ear biological sensor, performs, when the content is stereophonic, a stereophonic output operation such that the content is output from both a right ear sound output unit and a left ear sound output unit, or performs a monophonic output operation such that the content is output from one of the right ear sound output unit and the left ear sound output unit.

7. A reproduction method of a reproduction apparatus comprising:
a step of acquiring biological information from a biological sensor located at an earphone; and
a step of controlling an output operation of a content based on an acquisition state of the biological information.
